(19) United States
(12) Patent Application Publication
(10) Pub. No.: US 2018/0025583 A1
(43) Pub. Date: Jan. 25, 2018

(54) METHOD AND SYSTEM OF DELIVERING FUNDS OR ENTERTAINMENT TO A GAMING MACHINE FROM AN EXTERNAL SOURCE

(71) Applicant: David Haag, Las Vegas, NV (US)

(72) Inventor: David Haag, Las Vegas, NV (US)

(21) Appl. No.: 15/655,436

(22) Filed: Jul. 20, 2017

Related U.S. Application Data
(60) Provisional application No. 62/364,789, filed on Jul. 20, 2016.

(51) Int. Cl. G07F 17/32

(52) U.S. Cl. CPC G07F 17/3255; G07F 17/3211; G07F 17/3225; G07F 17/3246; G07F 17/3248

(57) ABSTRACT

A method and system is provided for funding a gaming machine from an external source. The gaming machine may include at least one wager accepting device configured to receive a first physical item associated with a monetary value to increase a credit balance at the gaming machine, and at least one promotion accepting device configured to receive a second physical item associated with promotional information. The method includes generating a gaming promotion associated with promotional information for direct redemption at the gaming machine where the promotional information comprising a promotional feature and tracking information. The method further includes receiving the second physical item that is associated with the gaming promotion via the at least one promotion accepting device, validating the gaming promotion at the gaming machine, activating the promotional feature via the processor, and reporting the tracking information associated with the gaming promotion.

### CROSS-REFERENCE TO RELATED APPLICATION

This application claims priority to U.S. Provisional Application No. 62/364,789 which was filed on Jul. 20, 2016, the contents of which are hereby incorporated by reference.

### BACKGROUND

### 1. Field

The disclosed embodiments relate to promotional operation of gaming devices. More specifically, the disclosed embodiments relate to delivering funds or entertainment to a targeted gaming machine from an external source.

### 2. Related Art

Traditional gaming machines are funded through electronic cashless transfer from a server, physical cash accepted by a bill validator, gaming machine printed tickets accepted by a bill validator, or coins. Typical wager gaming machines implement ticket-in/ticket-out technology that require a delivery of funds from a known internal source such as a prior gaming machine generated ticket. For example, when a player cashes out funds from a gaming machine, a ticket is printed from that gaming machine, and the player takes the printed ticket to another gaming machine. This typical implementation limits how and where a ticket can be generated thereby preventing a ticket to be acquired from a different region and used in an electronic gaming machine in an accompanying region. Another method of generating a ticket is from a kiosk located in the casino cage where casino employees can generate promotional tickets that can be used at any machine on the casino floor regardless of manufacturer or game type.

Prior to ticket-in/ticket-out technology used by most electronic gaming machines in the casino industry, electronic gaming machines accepted funds in the form of physical cash or coin. As ticket-in/ticket-out technology was adopted by the casino industry as a cost effective and more secure method of transferring funds to an electronic gaming machine, many regulation and security measures were devised to combat ticket duplication, re-use, and other forms of misuse. The security measures implemented, and time tested in the casino industry, allow for a ticket to be used by an electronic gaming machine that was not initially generated by an electronic gaming machine.

### SUMMARY

The disclosed embodiments relate to delivering funds or entertainment to a gaming machine from a wide range of non-gaming sources including, but not limited to: social media posts, magazine inserts, postal mail, flyers, email, and text messages. Funds delivered may be in the form of credits on an electronic gaming machine. Entertainment delivered would be delivered in many formats including changing the background color, adding special characters or lucky characters to the game, changing game messages, or other non-monetary changes to the game display or game play. Additionally, upon redeeming the promotional ticket, the gaming machine can post a social media event to one or more of several social media outlets (e.g. Facebook, Instagram, etc.) to describe the use of the ticket including where it was used and which game or manufacturer is being promoted.

One exemplary embodiment involves a method and system for distributing funds to an electronic gaming machine utilizing ticket-in/ticket-out technology where the ticket is not generated from an electronic gaming machine, a kiosk located in a gaming environment, a casino cashier cage, or the like. The ticket details are generated for use by a third-party distributor for promotional and/or entertainment purposes.

In some embodiments, the ticket generated is used to promote a new game on a specific manufacturer, or multiple manufacturers, platform or platforms, or any game or games on a specific manufacturer or multiple manufacturers platform or platforms on the property.

In one embodiment, the ticket generated may be used by any electronic gaming machine, an electronic table game, or a regular table game on a casino property. In other embodiments, the ticket generated may only be used by a specific, individual electronic gaming machine or a predetermined subgroup of gaming machines on the property. In another embodiment, the ticket generated may only be used for a specific game or game type on one or more manufacturer platforms. In yet a further embodiment, the ticket generated may be used only on a specific one or subset of electronic table games or regular table games. In some embodiments, the ticket generated is for a designated subset of a combination of electronic gaming machines, electronic table games, and regular table games.

Through modification of the existing protocols that support ticket-in/ticket-out technology, the disclosed embodiments allow for acceptance of externally created tickets for use by an electronic gaming machine to suit a promotional or entertainment purpose. These promotional tickets can be distributed through a variety of media including paper and electronic. One example of distribution is through a paper or electronic magazine. A store receipt may also be used, or a handout from a store, bar, or restaurant with a gaming machine readable code. A pre-printed ticket can be included in a paper magazine publication as an insert that may be used as a ticket in an electronic gaming machine.

The ticket may have additional embedded features in it to limit where the ticket can be redeemed. For example, the ticket may specify that it may only be redeemed at electronic gaming machines in casinos that are in a specific region of the world. The ticket may be configured to only operate on a certain brand of gaming machine, or for only a specific game on a gaming machine, such as to promote that game or company. Additionally, there may be a limited number of tickets that may be redeemed in order to limit liability and offer additional security. Alternatively, additional game skins (look, colors, and/or characters) may be enabled through use of the modified ticket such that these skins are not available without the promotional ticket. Other game features or options may only be enabled with the promotional ticket. Thus, the ticket may only be operable on certain platforms or may enable additional functionality.

To enable and provide the gaming method disclosed herein, a gaming machine may be provided which includes a controller; at least one electronic display; at least one player input device; one or more wager accepting devices such as a bill validator, a coin acceptor, or a ticket reader; and a memory storing machine-readable code. The controller may be a processor. The machine-readable code is executable by the controller to control gaming machine functionality and to present game information to the player, such as to accept a wager from a credit balance on the gaming machine, to deal cards, spin reels, and otherwise present random or non-random game play functionality to the player. The controller may be configured to award winnings of game-play to a credit balance, and to cash out the credit balance on the gaming machine by adding credits to a player account, by printing a ticket, dispensing coins, or the like.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 is a gaming machine according to an exemplary embodiment.

FIG. 2 is a schematic of gaming machine components, according to an exemplary embodiment.

FIG. 3 is a schematic of a system for funding a gaming machine from an external source, according to one exemplary embodiment.

FIG. 4 is a method of funding a gaming machine from an external source, according to one exemplary embodiment.

FIG. 5 is a schematic of a computing or mobile device such as one of the devices described above, according to one exemplary embodiment.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

In one embodiment, the system and methods of providing funds from an external source are implemented on or via a gaming machine or gaming system. Such a gaming machine may have various configurations.

The gaming machine may be located at a casino (and as such may be referred to as an “Electronic Gaming Machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

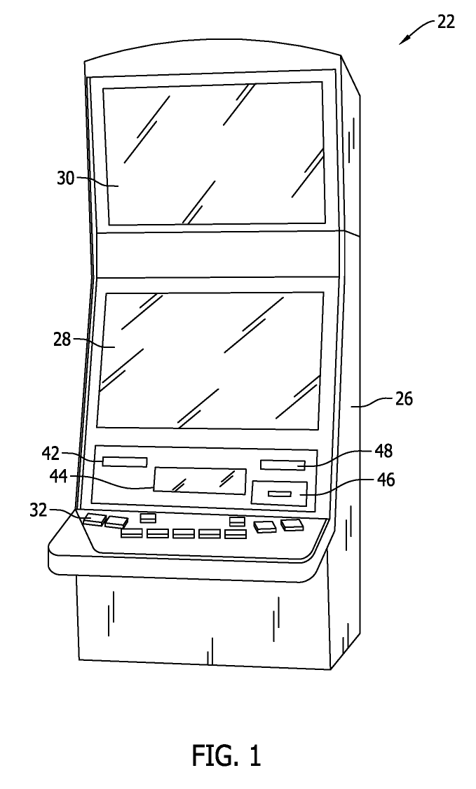

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one first display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display device 28 may be capable of projecting or displaying a wide variety of information, including images, symbols and other indicia or information associated with game play, game promotion or other events. The gaming machine 22 might include more than one display device, such as a main or first display device 28 and a secondary display device 30. The two or more display devices might be associated with the housing or, as illustrated in FIG. 1, the gaming machine 22 might also include a top box or other portion which includes the one or more second display devices 30. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes mechanism or means for accepting a monetary value or any equivalence thereof.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 32 (such as input buttons, plunger mechanisms, a touch-screen display, joystick, touch-pad or the like). These one or more devices 32 may be utilized by the player to facilitate game play, such as by providing input or instruction to the gaming machine 22. For example, such input devices 32 may be utilized by a player to place a wager, cause the gaming machine 22 to initiate a game, to initiate designated markers marking “lucky spots,” to “cash out” of the gaming machine, or to provide various other inputs.

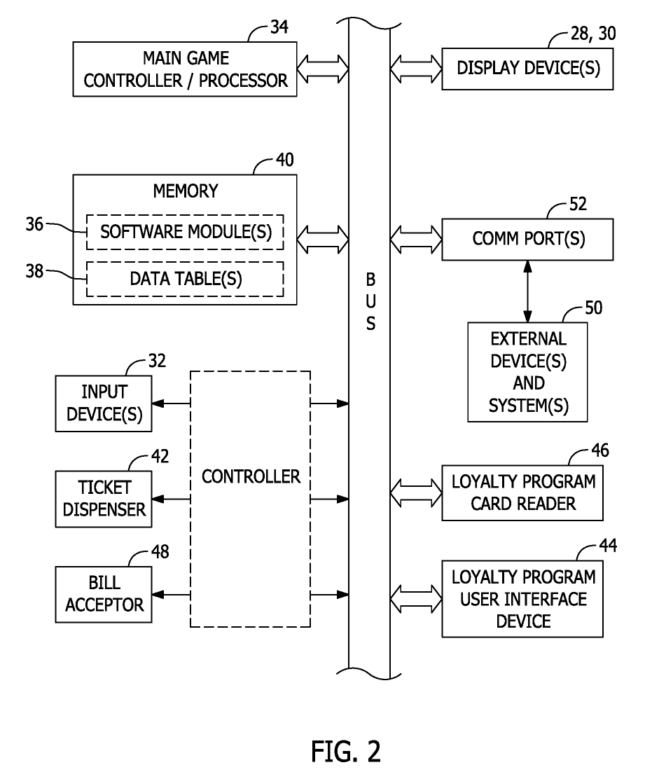

Referring to FIG. 2, in one preferred embodiment, the gaming machine 22 includes at least one microprocessor or controller 34 for controlling the gaming machine, including receiving player input and sending output signals for controlling the various components or peripheral devices of the machine 22 (such as generating game information for display by the display devices 28, 30). The controller 34 may be arranged to receive information regarding funds provided by a player to the gaming machine 22, receive input such as a purchase/bet signal when a purchase/bet button is depressed, and receive other inputs from a player. The controller may be arranged to generate information regarding a game, such as generating game information for display by the at least one display device 28, 30 (such as information comprising lucky spot features and relocatable gaming pieces, as detailed below), for determining winning or losing game outcomes and for displaying information regarding awards for winning game outcomes, among other things.

The controller 34 may be configured to execute machine readable code or “software” or otherwise process information, such as obtained from a remote server. Software 36 or other instructions may be stored at a memory or data storage device 40, e.g. in a fixed or non-transitory configuration. The memory may also store other information or data 40, such as data stored in table or other forms (including, but not limited to look-up tables, pay tables and other information including tracked game play information). The gaming machine 22 may also include one or more random number generators for generating random numbers (such as implemented by a pseudo-random number generator software module stored in the memory 40 and executable by the processor 34), such as for use in dealing game pieces to a player, for selecting multiplier values, for positioning game elements in a random fashion, or other randomized game functionality.

Preferably, the controller 34 is configured to execute machine readable code or instructions (e.g. software) which are configured to implement the game. In this regard, the gaming machine 22 is specially configured to present a game, to receive funding from internal or external sources, or the like via specific software and/or hardware which causes the gaming machine to operate uniquely. For example, the controller 34 of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. As indicated above, the machine-readable code may be configured in various manners, such as by having various “modules” of software which are designed to implement specific features of the game play or game presentation.

The gaming machine 22 may be configured to generate and present games in a stand-alone manner, or it may be in communication with one or more external devices or systems 50 at one or more times. The gaming machine 22 might communicate with one or more of such external devices or systems 50 via one or more communication ports 52 or other interface devices. These ports or interface devices 52 may be configured to implement various communication protocols (including proprietary protocols) and communicate via wireless, wired or other communication link. For example, the gaming machine 22 may be configured as a client based device and obtain game code or game outcome information from a central game server (in which event the gaming machine controller may receive game information from the server, such as game outcome information, and use that server-generated information to present the game at the gaming machine).

For example, in a gaming machine in a Class II gaming system, a central server sends game outcome information based on a physical or electronic pull-tab or based on a Bingo game outcome. For another example, in a gaming machine in a Video Lottery Terminal system, a central server sends game outcome information based on an electronic lottery ticket, or based on a random number generator or based on a pseudo-random number generator. For another example, in a personal video game device such as a mobile phone, tablet, laptop, desktop, PDA or any suitable personal video game device in an online or mobile client-server system, a central server sends game outcome information of any kind.

As indicated, the gaming machine 22 is configured to present one or more wagering games. The gaming machines 22 is preferably configured to accept some form of funding, such as funding in the form of coins, tokens, paper currency, Ticket-In-Ticket-Out (TITO) tickets, virtual currency, free play credits or other suitable funding elements, objects or devices representing value such as monetary funds. Thus, as indicated above, the gaming machine 22 preferably includes a mechanism or means for accepting monetary value. For example, the gaming machine 22 might include a media reader such as bill acceptor 48 for accepting paper monetary currency. The gaming machine 22 may also include a TITO reader/dispenser 42 that accepts and dispenses TITO tickets. Other associated devices for the reading, verification, and storage of the paper monetary currency and/or monetary currency equivalents are provided including the communication infrastructure between the associated devices and the at least one control processor within gaming machine 22. In another embodiment, the gaming machine 22 might include a coin acceptor for accepting, validating and storing coins.

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system).

When the player associates funds with the gaming machine or an associated system, a credit balance is generated. The amount by which given funds are converted to credits is usually referred to the given game's “denomination”. For example, inserting a $100 bill into a gaming machine with a $1 denomination results in a credit balance increase of 100 credits, whereas inserting a $100 bill into a gaming machine with a $5 denomination results in a credit balance increase of only 20 credits. Therefore, there is typically a direct correspondence between the number of credits wagered and the actual funds put at risk for the wager. The credit balance may comprise a plurality of monetary value credits. The player may wager some or all of the associated monetary value, such as by wagering one or more of the credits associated with the credit balance. For example, in a gaming machine with a $1 denomination, the player might provide input to a wager button or touch screen interface to wager a certain number of credits (such as “Bet 1 Credit”, “Bet 5 Credits”, “Bet Maximum Credits” or other options) which is essentially specifying a wager of the same number of dollars as credits. In a similar example with a gaming machine with a $0.25 denomination, each credit wagered is essentially specifying a wager of a quarter. In one embodiment, when the player's wager is received, the player's credit balance is reduced by the number of wagered credits. The player might then provide a separate input to begin the game. In other embodiment, the player might select a “play game” input, such as by pressing a “spin” button or “deal” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In some embodiments, the credit balance may be comprised of restricted and non-restricted credits. The restricted credits may be, for example, promotional credits that are only redeemable for game play at the gaming machine, but may not be redeemed for cash. Restricted credits may be added to the gaming machine via a TITO device from a coupon or other promotion redeemable at a casino, as described in more detail below.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or a “collect” button or a touch screen feature or providing other input. In response, a monetary value represented by the player's credit balance or the like is preferably paid, transferred or otherwise provided to the player. For example, upon an award or at cash-out, associated funds may be paid to the player by the gaming machine 22 via a media such as a TITO ticket from a TITO ticket dispenser 42, wherein the TITO ticket represents the value which was paid or cashed out of the machine. In another embodiment not shown, funds may be issued by dispensing coins to a coin tray. In another embodiment not shown, funds may be issued by dispensing paper currency or other media. The aspects of gaming machine “ticketing” systems are well known. One such system is described in U.S. Pat. No. 6,048,269 to Burns, which is incorporated herein in its entirety by reference.

In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. The media writer may also update a value on other media, such as a player tracking system or loyalty program card. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player loyalty program card reader 46, and a loyalty program user interface device 44. The interface device 44 may include a display device, and/or a player input device such as a keyboard, touch screen, or other input device. In some embodiments, the interface device 44 may include an interface to communicate with an external input device such as a player's mobile phone, PDA, or any other suitable external input device (the external device being a separate device from the gaming machine 22). Such player loyalty program cards are well known and may permit the game operator to track play of the particular player of the gaming machine whose player loyalty program card is inserted into the gaming machine. The play tracking may be used to award the player with loyalty program points, the accumulation of which results in some benefit to the player.

As illustrated in FIG. 2, the main game controller or processor 34 may communicate with several of the peripheral devices via one or more intermediary controllers. For example, some of the peripheral devices might comprise USB type or enabled devices which are controlled by an intermediary USB controller.

A casino may have numerous such gaming machines 22, such as located on a casino floor or in other locations. Of course, such gaming machines 22 might be used in other environments, such as an airport, bar or tavern or other locations.

It will be appreciated that the gaming machine illustrated in FIGS. 1 and 2 is only exemplary of one embodiment of a gaming machine. For example, it is possible to for the gaming machine to have various other configurations, including different shapes and styles and having different components than as just described.

The gaming machine 22 may, as noted above, be part of a system which includes other devices. For example, the gaming machine 22 may communicate with one or more casino systems, such as a player tracking server or system, an accounting system or server, a ticketing system, a bonusing system, a tournament system, other gaming machines, and external devices.

In some embodiments, a gaming system comprised of multiple devices in two or more separate locations within the same facility or different facilities are provided. Such systems may include a Video Lottery Terminal implementation or a Class II system implementation where game outcomes are generated in at least one central server which communicates with one or more player terminals on the casino floor via one or more wired or wireless connections.

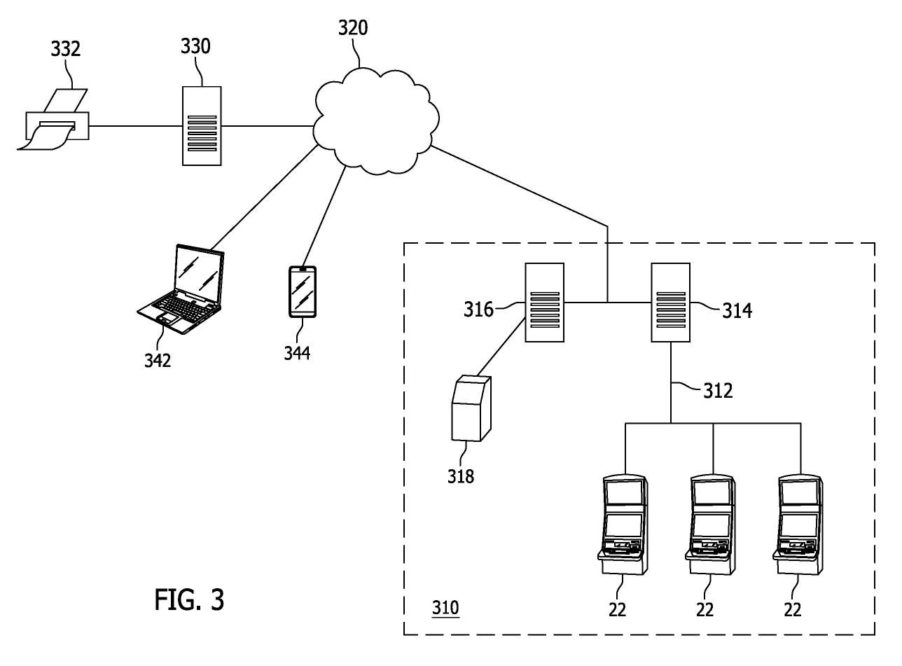

FIG. 3 is a schematic of a system for funding a gaming machine from an external source, according to one exemplary embodiment. In FIG. 3, a casino property 310 may include a casino network 312. The casino network 312 may connect gamine machines 22 located at the casino property 310 to a gaming server 314. The gaming server 314 may be configured to provide gaming information to the gaming machines 22. The gaming machines 22 and gaming server 314 may be connected to other devices at the casino property 310 such as an accounting server 316 and kiosk 318. As explained above, TITO tickets typically are generated at the casino property 310 via a casino cashier or automatically at an accounting kiosk 318 or gaming machine 22.

The casino network 312 may be connected to an external network 320, such as the Internet, to connect to a plurality of external devices. Such devices may include an external server 330. The external server 330 may be a server operated by an entity providing a promotion, such as a gaming machine manufacturer. The external server 330 may be connected to a printing device 332. Consumer computing devices 342, 344 may also connect to the casino network 310 via the external network 320.

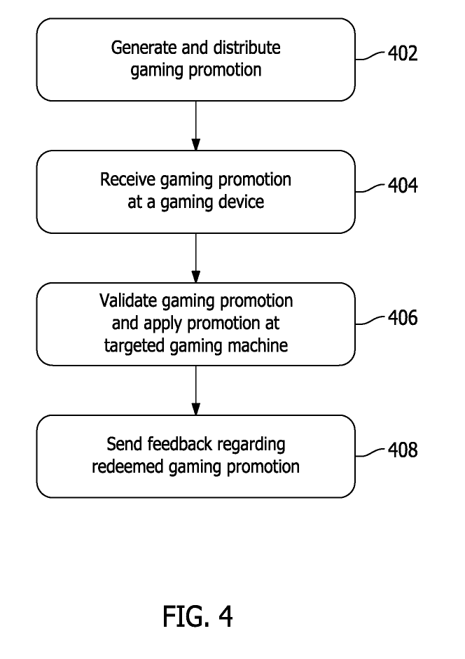

FIG. 4 is a method of funding a gaming machine from an external source, according to one exemplary embodiment. In step 402, a gaming promotion is generated and distributed. This may be done in a variety of fashions. In one example, a casino property may generate a promotion to play one or more gaming machines. In another example, a gaming manufacturer may generate a promotion for a game or gaming machine that may be offered at one or several casino properties.

The gaming promotion may take on a variety of forms. For example, the promotion may be for a certain number of restricted or non-restricted credits, or may include options to change or add game features such as background colors, themes, adding special characters to a game, changing game messages, and the like. The gaming promotion may thus include controls so that the promotion applies to only specific gaming machine features.

For example, the restricted credits added to the gaming machine may be limited to certain activities on the machine. For example, the restricted credits may only be used for playing one of a plurality of games offered at a gaming machine. The restricted credits may also only be valid for a game at certain, predetermined gaming machines at the casino property. This ensures that the credits are used only on the promoted product, and not for any gaming activity at the gaming machine.

As mentioned above, the gaming promotion may be specific to certain gaming machines located at a casino property. For example, the gaming promotion may be for gaming machines from a predetermined manufacturer, gaming machines offering a certain game, predetermined gaming machine platforms, predetermined locations at a casino property, or the like.

In one embodiment, the gaming promotions are generated externally from the casino property. Specifically, the gaming promotion is generated outside the typical TITO systems, but is redeemable directly at the gaming machine. That is, the externally generated gaming promotion does not need to be redeemed first at a casino cage or an accounting kiosk. Rather, the gaming promotion is accepted at the gaming machine itself.

The generated gaming promotion may be created through a variety of mediums. For example, the gaming promotion may be generated by a casino property, a gaming machine manufacturer, or any other entity, and may be printed coupons published in a magazine, on a mailer, in a newspaper, on a receipt, or the like. The printed coupon may be cut out by a consumer for direct redemption at a gaming machine. The printed coupon may thus comprise machine-readable information, such as a one or two-dimensional bar code. The machine-readable information may comprise information including the offer or features to be redeemed, a serial number of the coupon or other tracking information. The tracking information may be associated with marketing campaigns to track the medium and location in which the coupon was distributed.

The generated gaming promotion may also be generated electronically to be distributed via email, text messaging, social media, websites, etc. A user receiving the generated promotion may print the promotion from a personal printer. In another embodiment, the generated promotion may be stored on a user's mobile device for redemption at the gaming machine.

As one example of a generated promotion referring again to FIG. 3, the server 314, 316 at the casino property 310, or an external server 330 may generate a promotion. The promotion may be distributed electronically or may be printed via the printing device 332 such as for a magazine, a mailer, etc. The electronical promotion may be sent through a network 320 to be accessed by computing device 342 or portable device 344.

Returning to FIG. 4, the gaming promotion is received at a gaming machine for redemption, as shown in step 404. As mentioned above, the gaming promotion is redeemable directly at the gaming machine without first presenting the gaming promotion at a casino cage or at a casino accounting kiosk. This may be done in several manners.

In one embodiment, a printed gaming promotion is sized to fit into the TITO reader/dispenser 42 such that the gaming machine 22 reads the machine-readable information from the insertable gaming promotion. In another embodiment, a gaming machine 22 includes a bar-code scanner that scans the machine-readable information from the printed gaming promotion without requiring the coupon to be inserted into the gaming machine.

In some embodiments where the gaming promotion is stored electronically on the user's mobile device 344, the user may transmit the gaming promotion to the gaming machine via a wireless transmission. For example, the user may connect to the gaming machine 22 using one of several known wireless protocols such as NFC, Bluetooth, WiFi, or the like. In another embodiment, an optical code may also be read from the screen of the mobile device 344 by the bar-code scanner of the gaming machine 22.

In other embodiments, the mobile device 344 may scan a one or two-dimensional barcode on the gaming machine. Upon scanning the code, the mobile device may include an application that sends information to the gaming server 314 or accounting server 316 to redeem the gaming promotion at the gaming machine 22.

In step 406, the gaming promotion presented at the gaming machine is validated and applied. Based on the gaming promotion, the gaming machine 22 may communicate with the game server 314 and/or the accounting server 316 to implement the promotion. The gaming server 314 and/or the accounting server 316 may communicate with one or more external servers 330 via the external network 320 to verify the promotion. The gaming machine 22 may then implement the promotion features, such as by adding restricted credits to a credit balance to play one or more games at the gaming machine, changing a game theme, adding a special character or symbol, or the like.

The validation of the gaming promotion may be controlled by several factors. For example, one or more of the gaming machine 22, the game server 314, or the accounting server 316 may verify that the gaming promotion is not expired, that the gaming promotion is being applied on a gaming machine covered by the promotion, that the serial number of the gaming promotion has not yet been redeemed, or the like. Other security or controls may be added to the gaming promotion as needed.

In step 408, the gaming machine 22, gaming server 314, or account server 316 may record and send feedback information regarding the redeemed gaming promotion. This may take several forms. In one embodiment, the gaming promotion is serialized such and the serial number of the redeemed gaming promotion is reported. In this manner, the gaming promotion may be correlated with the distribution channel to measure the effectiveness of a marketing campaign. For example, the serial number of the gaming promotion may be correlated with a marketing campaign distributed via a printed magazine or via social media. The report helps to indicate the effectiveness of the campaign to better target future gaming promotions to a particular audience.

In another embodiment, the feedback may include information on the player redeeming the promotion. For example, when the player redeems the promotion, the player may be required to input an email address, personal identification information, or the like. In some instances, the redemption information is correlated with player information from a player tracking system. This helps to target future promotions to predetermined audiences.

In further embodiments, the feedback information may include a time and place of redemption. For example, a time of the day, the day of the week is reported. Further, the place of redemption may be recorded such as a particular casino property, a particular bank of machines at a casino property, and/or the particular gaming machine on which the promotion was redeemed. All of the information helps to correlate how the distributed gaming promotion is reaching the target audience.

It is noted that in the above explanation, the promotion is described as being redeemed at a gaming machine. However, the method and system may similarly apply to other gaming devices at a gaming establishment such as an electronic table game or a regular table game. The promotion may be targeted towards any one or subset of the electronic table games or table games at a gaming establishment, or at any combination or subset of gaming machines, electronic table games, and table games.

In the embodiments described above, the systems and methods require the use of various devices that each include computing devices. Examples of such devices may include various mobile devices such as a smartphone, tablet computing device, a laptop, etc. Other devices may include desktop computers, servers, or “wearable” technology such as smart watches, exercise activity monitors, or the like. Other “smart” devices including a variety of everyday objects which are reconfigured to incorporate a computing device and a transceiver for accessing a network may be utilized. These devices are often referred to as “Internet of Things” devices.

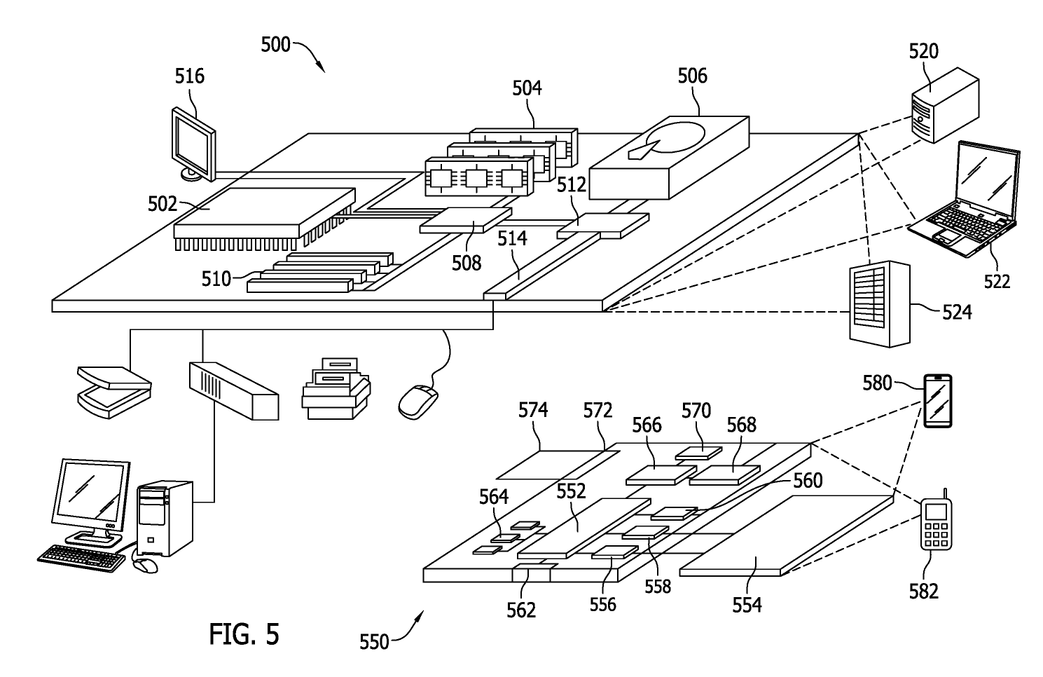

FIG. 5 is a schematic of a computing or mobile device such as one of the devices described above, according to one exemplary embodiment. FIG. 5 shows an example of a computing device 500 and a mobile computing device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit the implementations described and/or claimed in this document.

Computing device 500 includes a processor 502, memory 504, a storage device 506, a high-speed interface or controller 508 connecting to memory 504 and high-speed expansion ports 510, and a low-speed interface or controller 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed controller 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of functions is exemplary only. In one implementation, the high-speed controller 508 is coupled to memory 504, display 116 (e.g., through a graphics processor or accelerator), and to high-speed expansion ports 510, which may accept various expansion cards (not shown). In the implementation, low-speed controller 512 is coupled to storage device 506 and low-speed bus 514. The low-speed bus 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chip set of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wifi, or other such transceiver (not shown). In addition, GPS (Global Positioning system) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 500 and/or 550) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for funding a gaming machine from an external source, the gaming machine comprising a processor, at least one display, at least one input device, at least one wager accepting device configured to receive a first physical item associated with a monetary value to increase a credit balance at the gaming machine, and at least one promotion accepting device configured to receive a second physical item associated with promotional information, the method comprising:
generating a gaming promotion associated with promotional information for direct redemption at the gaming machine, the promotional information comprising a promotional feature and tracking information;
receiving the second physical item that is associated with the gaming promotion via the at least one promotion accepting device;
validating the gaming promotion at the gaming machine;
activating the promotional feature via the processor; and
reporting the tracking information associated with the gaming promotion.

2. The method of claim 1, wherein the second physical item is a printed coupon.

3. The method of claim 1, wherein the second physical item is a mobile device of a player, and the at least one promotion accepting device receives the gaming promotion from the mobile device.

4. The method of claim 3, wherein the at least one promotion accepting device comprises at least one of a NFC transceiver, a Bluetooth transceiver, a Wi-Fi transceiver, and a bar code reader.

5. The method of claim 3, wherein a bar code on the gaming machine is scanned by the mobile device to initiate the receiving of the gaming promotion from the mobile device.

6. The method of claim 1, wherein the promotional feature comprises promotional credits, and wherein the activating step comprises increasing the credit balance with the promotional credits.

7. The method of claim 6, wherein the promotional credits are restricted credits.

8. The method of claim 1, wherein the promotional feature comprises one or more of a game theme, a special character, and a special symbol.

9. The method of claim 1, wherein the tracking information comprises a serial number.

10. A gaming machine comprising
at least one display;
at least one input device;
at least one wager accepting device configured to receive a first physical item associated with a monetary value to increase a credit balance at the gaming machine;
at least one promotion accepting device configured to receive a second physical item associated with promotional information;
a processor; and
a memory storing machine-readable instructions, which when executed by the processor, cause the gaming machine to:
receive the second physical item that is associated with a gaming promotion via the at least one promotion accepting device, the gaming promotion being associated with promotional information for direct redemption at the gaming machine, the promotional information comprising a promotional feature and tracking information;
validate the gaming promotion;
activate the promotional feature via the processor; and
report the tracking information associated with the gaming promotion.

11. The method of claim 10, wherein the second physical item is a printed coupon.

12. The method of claim 10, wherein the second physical item is a mobile device of a player, and the at least one promotion accepting device receives the gaming promotion from the mobile device.

13. The method of claim 12, wherein the at least one promotion accepting device comprises at least one of a NFC transceiver, a Bluetooth transceiver, a Wi-Fi transceiver, and a bar code reader.

14. The method of claim 12, wherein a bar code on the gaming machine is scanned by the mobile device to initiate the receiving of the gaming promotion from the mobile device.

15. The method of claim 10, wherein the promotional feature comprises promotional credits, and wherein the process activates the promotional feature by increasing the credit balance with the promotional credits.

16. The method of claim 15, wherein the promotional credits are restricted credits.

17. The method of claim 10, wherein the promotional feature comprises one or more of a game theme, a special character, and a special symbol.

18. The method of claim 10, wherein the tracking information comprises a serial number.
